(19) United States
(12) Patent Application Publication
(10) Pub. No.: US 2024/0338182 A1
(43) Pub. Date: Oct. 10, 2024

(54) AUTOMATED CREATION OF SOFTWARE PROGRAM STRUCTURE HAVING RUNNABLE SOFTWARE CODE

(71) Applicant: Insight Direct USA, Inc., Chandler, AZ (US)

(72) Inventor: Timothy Hennessy, Palm Beach Gardens, FL (US)

(21) Appl. No.: 18/603,677

(22) Filed: Mar. 13, 2024

Related U.S. Application Data
(60) Provisional application No. 63/457,650, filed on Apr. 6, 2023.

(51) Int. Cl. G06F 8/35; G06F 8/20; G06F 8/77

(52) U.S. Cl. CPC G06F 8/35; G06F 8/20; G06F 8/77

(57) ABSTRACT

A method of creating a software program structure for a project is presented. A plurality of project inputs are collected, including a type of software program that is to be created and at least one of: client name, application/project name, database server name, database name, username, password, custom message, configuration key, and cache system key. At least one structure placeholder in the software program structure is replaced with first project information dependent upon the plurality of project inputs, and at least one code placeholder in software code of the software program structure with second project information dependent upon the plurality of project inputs. The software program structure for the project is provided, including first project information and software code that include second project information. The software code is fully runnable software code that does not require further editing.

### CROSS-REFERENCE TO RELATED APPLICATION

The present application claims priority to U.S. provisional patent application Ser. No. 63/457,650 by T. Hennessy, filed Apr. 6, 2023 and entitled “AUTOMATED CREATION OF SOFTWARE PROGRAM STRUCTURE HAVING RUNNABLE SOFTWARE CODE.”

### FIELD OF THE INVENTION

The disclosure relates generally to software program development, and more specifically to a system and method for automating the creation of a software program structure having software code that is fully runnable.

### BACKGROUND

In developing software programs, a particular software program structure can be used to organize the software code for optimal functionality. This structure can include various folders, sub-folders, formats, directories, and/or other organizations to allow a developer/user to view, edit, and/or access the information within the structure. Additionally, many software programs may have similar portions of code that perform the same or similar functions. Usually, the software program structure is created by one or multiple developers each time from scratch, with each developer having his/her own personal preferences and style. Differing software program structures can be confusing for the developers that did not create and/or select that structure but are otherwise working on the project, and delivering multiple projects/products to one client that each contain a different software program structure can be less than ideal.

### SUMMARY

This disclosure presents a method of creating a software program structure for a project. A plurality of project inputs are collected, including a type of software program that is to be created and at least one of: client name, application/project name, database server name, database name, username, password, custom message, configuration key, and cache system key. At least one structure placeholder in the software program structure is replaced with first project information dependent upon the plurality of project inputs, and at least one code placeholder in software code of the software program structure with second project information dependent upon the plurality of project inputs. The software program structure for the project is provided, including first project information and software code that include second project information. The software code is fully runnable software code that does not require further editing.

This disclosure also presents a system for creating a software program structure for a project. This system is located on computer hardware and includes a project input file, a placeholder database, a structure creation module, and the software program structure itself. The project input file has a plurality of project inputs including a type of software program that is to be created and at least one of: client name, application/project name, database server name, database name, username, password, custom message, configuration key, and cache system key. The placeholder database contains a list of at least one structure placeholder in the software program structure and the at least one code placeholder in software code of the software program structure. The structure creation module is communicatively coupled with the project input file and the placeholder database, and has a computer processor configured to replace the at least one structure placeholder in the software program structure with first project information dependent upon the plurality of project inputs and replace the at least one code placeholder in software code of the software program structure with second project information dependent upon the plurality of project inputs. The software program structure includes the software code having the second project information with the software code being fully runnable software cod that does not require further editing.

The present summary is provided only by way of example, and not limitation. Other aspects of the present disclosure will be appreciated in view of the entirety of the present disclosure, including the entire text, claims, and accompanying figures.

### BRIEF DESCRIPTION OF THE DRAWINGS

FIG. 1 is an example of a schematic of the system for creating a new project software program structure.

FIG. 2A an example of a user interface element featuring a dialog box for selecting a type of software program structure for the new project.

FIG. 2B is an example of user interface element featuring a parameter input dialog box for inputting project inputs for the new project.

FIG. 2C is an example of user interface element visualizing a software program structure for an application programming interface (API) structure.

FIG. 2D is an enlarged view of the user interface element of FIG. 2C, visualizing the example API structure and showing the six classes containing software code that is fully runnable.

While the above-identified figures set forth one or more examples of the present disclosure, other examples/embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale, and applications and examples of the present invention may include features and components not specifically shown in the drawings.

### DETAILED DESCRIPTION

Systems and related methods are disclosed herein for use in creating a project software program structure for a project/program that includes runnable software code ready to be checked into a client repository. The systems and methods can automatically create a project software program structure, such as an application programming interface (hereinafter referred to as “API”) structure. The software program structure can have a particular, replicable organization. The organization of the software program structure is suitable for the particular project/program that is being created, and can differ depending on the project/program that is to be created. Each type of program that can be created by the disclosed systems and method can have a specific structure, providing consistency for clients and developers. The software program structure can include software code specific to the type of program that is being created as well as template code that can aid developers in creating/adding additional code to the project software program structure for the project/program after the particular project software program structure has been created. The systems and methods can include a placeholder database that includes one or multiple tokens that link project inputs with placeholders within the selected software program structure and/or the software code. The systems and methods can be configured to replace/substitute the placeholders with information dependent upon the project inputs to create a particular project software program structure that includes project-specific, runnable software code that is ready to be checked into the client repository.

The software code that is within the newly created project software program structure can be finished, runnable, and able to be checked into client repository for storing and use by the client without the need for further editing. The software code can be a “best practices” code that is developed and refined by the company/developers beforehand to be code that is the most efficient, easily editable, simplest, shortest, transferrable, etc. The systems and methods can accommodate/create a variety of different types of software program structures, such as an API structure, a web application structure, a system software structure, a desktop application structure, and others not expressly disclosed herein. The various capabilities, functions, configurations, and advantages of the systems and methods will be realized by reviewing this disclosure.

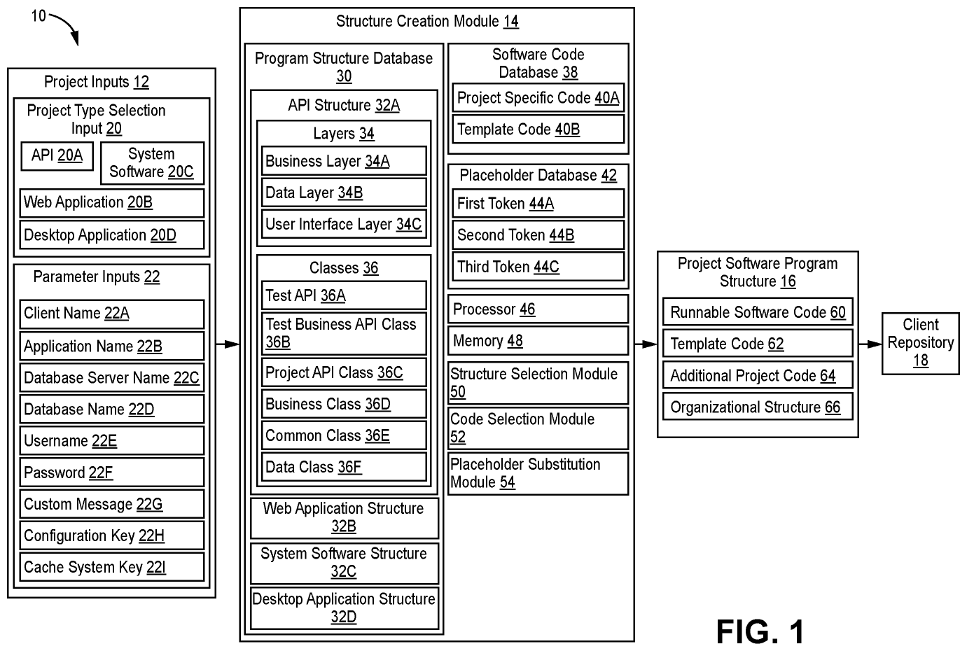

FIG. 1 is an example of a schematic of the system for creating a new project software program structure for a new project/program. System 10 can include project inputs 12, structure creation module 14, project software program structure 16, and client repository 18. Project inputs 12 can include example project type selection input 20 having API 20A, web application 20B, system software 20C, and/or desktop application 20D and example parameter inputs 22 having client name 22A, application/project name 22B, database server name 22C, database name 22D, username 22E, password 22F, custom message 22G, configuration key 22H, and/or cache system key 22I. Project inputs 12 are provided to structure creation module 14.

Structure creation module 14 can include program structure database 30 having example structures 32, including API structure 32A, web application structure 32B, system software structure 32C, and desktop application structure 32D. Example API structure 32A can include layers 34 (having example business layer 34A, data layer 34B, and/or user interface layer 34C) and classes 36 (having example test API class 36A, test business API class 36B, project API class 36C, business class 36D, common class 36E, and/or data class 36F). Structure creation module 14 can also include software code database 38 having project specific code 40A and template code 40B as well as placeholder database 42 having examples first token 44A, second token 44B, and third token 44C. Structure creation module 14 can further include processor 46, memory 48, structure selection module 50, code selection module 52, and/or placeholder substitution module 54.

System 10 can create project software program structure 16, which can include runnable software code 60, template code 62, additional project code 64, and organizational structure 66. Project software program structure 16 can be checked into (e.g., sent to and/or stored on) client repository 18 for access and use by a client that requested the creation of a project/program having project software program structure 16 suitable for performing tasks as specified by the client.

System 10 and/or structure creation module 14 can be a discrete assembly or be formed by one or more devices capable of individually or collectively implementing functionalities and creating project software program structure 16. In some examples, system 10 and/or structure creation module 14 can be implemented as a plurality of discrete circuitry subassemblies. In some examples, one or all components of system 10 can include or be implemented at least in part as a smartphone or tablet, among other options. In some examples, one or all components of system 10 can include and/or be implemented as downloadable software in the form of a mobile application. The mobile application can be implemented on a computing device, such as a personal computer, tablet, or smartphone, among other suitable devices. One or all components of system 10, such as structure creation module 14, can be considered to form a single computing device even when distributed across multiple component devices.

System 10, as well as structure creation module 14, can include other components not expressly disclosed herein, such as a user interface that allows for a user/developer to provide project inputs 12, access and/or manipulate the functionality of structure creation module 14, access and/or manipulate project software program structure 16, access and/or manipulate the information in client repository 18, and/or provide other capabilities, functions, and/or configurations. Structure creation module 14 can include and/or use machine learning to create project software program structure 16 depending on project inputs 12.

As shown in FIG. 1, project inputs 12 include two types of inputs: project type selection input 20 and parameter inputs 22. Project type selection input 20 allows for a user (such as a client, a developer, or another) to select the type of project that is to be created by system 10, with the selection in project type selection input 20 determining the final organization/structure of project software program structure 16. The selection made in project type selection input 20 can determine which structure 32 is automatically selected/chosen by structure selection module 50 from program structure database 30 of structure creation module 14. Project type selection input 20 can include options for selecting any type of project to be created by system 10. In the example shown in FIG. 1, project type selection input 20 has four options for project type/organization: application programming interface (API) 20A, web application 20B, system software 20C, and desktop application 20D. Each of the options of project type selection input 20A-20D offer a different program organizational structure 66 for organizing runnable software code 60, template code 62, and/or additional project code 64 in project software program structure 16. Project type selection input 20 can include other information and/or prompt the selection of other inputs, such as subtypes of each project type 20A-20D, the type of software language used in project software program structure 16, and/or other inputs/information.

Based on project inputs 12 and/or parameter inputs 22, structure creation module 14 can automatically create project software program structure 16 and automatically include within project software program structure 16 runnable software code 60, template code 62, and/or organizational structure 66 depending on inputs 12 and/or 22. System 10 automatically creates a uniform structure with code each time a program structure is created depending on inputs 12 and/or 22.

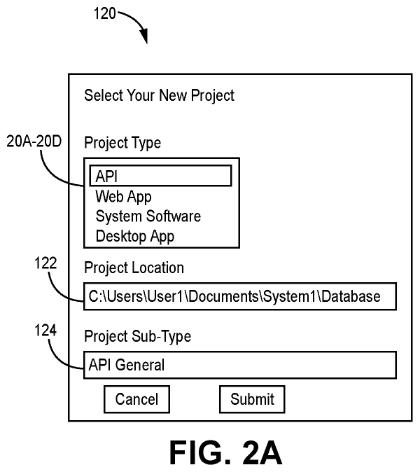

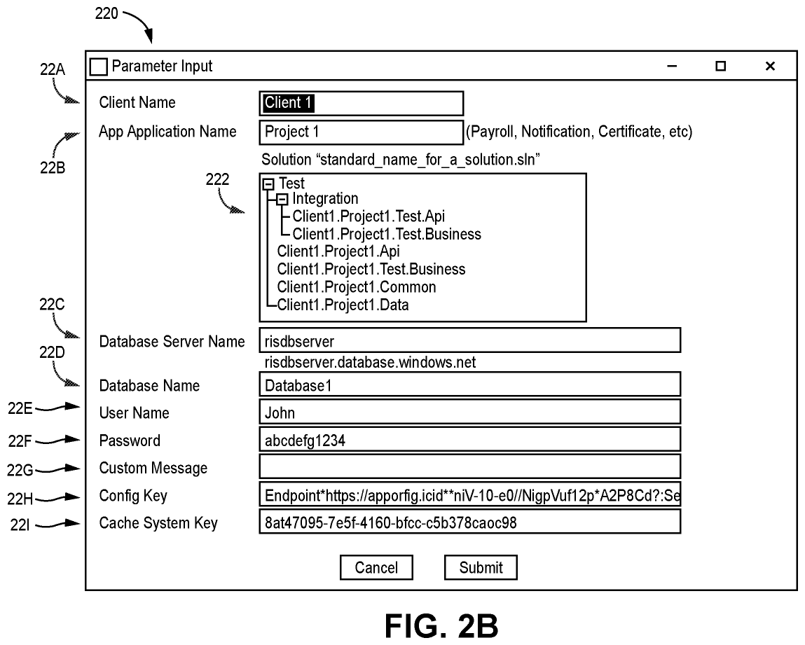

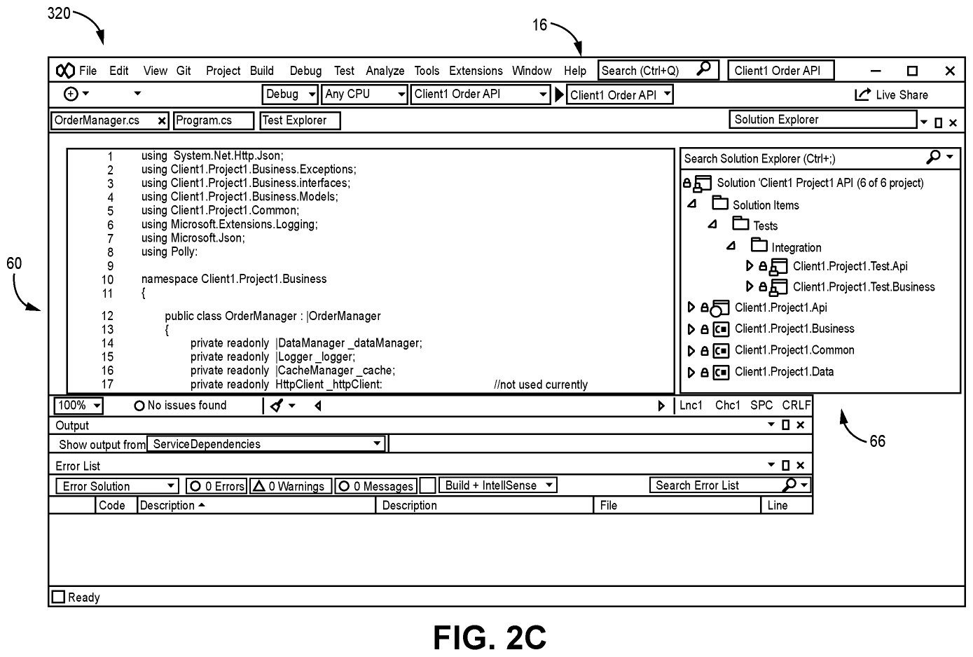

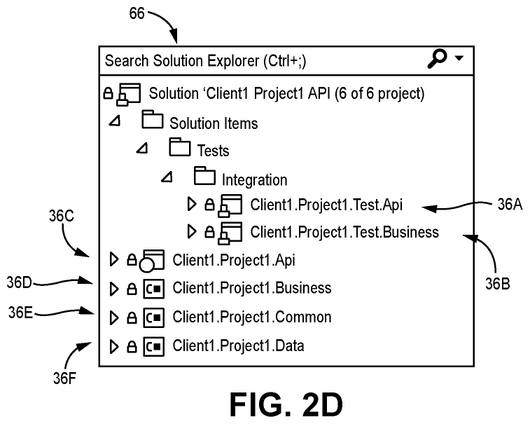

FIG. 2A shows an example of new project dialog box 120 for choosing/inputting project type selection input 20. Using dialog box 120, a user/developer can select project type 20A-20D from a drop-down or other menu. The user/developer can select other inputs in dialog box 120, such as project location 122, which can allow for user/developer to designate the location from which to retrieve the structure/organization of the project selected in project type selection input 20 and/or allow for user/developer to designate the location to which new project software program structure 16 is temporary or permanently saved/stored. Project location 122 can have other functions and/or be used for the designation of locations for other aspects of system 10. The user/developer can also select project-sub-type 124 in dialog box 120, thereby selecting or identifying a particular type/structure/organization of project type 20A-20D. The selection in project sub-type 124 can be dependent upon the selection of project type 20A-20D with the options for which project sub-type 124 can be selected populating and unpopulating (such as in a drop-down menu) as the selected project type 20A-20D changes. In FIG. 2A, for example, project type 20A-20D is selected to be API 20A and project sub-type 124 is designated to be a general structure/organization of the API structure. In another example, project type 20A-20D can be selected to be web application 20D, and project sub-type 124 can provide different web application sub-type options, such as static, dynamic, E-commerce, single-page, portal, content management system, animated Rich Internet, and/or others. Dialog box 120 can provide for the inputs/selections of other information and/or can be combined with dialog box 220 (described below) to allow for the user/developer to provide information/selections as necessary to allow system 10 to create project software program structure 16. Project type 20A-20D and/or project sub-type 124 (like other groupings disclosed herein) can be stored in memory 48 and pulled accessed by any component of structure creation module 14, such as structure selection module 50, code selection module 52, and/or placeholder substitution module 54.

Project inputs 12 can also include parameter inputs 22. Parameter inputs 22 allow for a user/develop to select/enter information regarding the particular/specific project to be created. This information can be used by system 10 (e.g., structure creation module 14) to select the project specific code 40 and template code 40B from software code database 38, substitute placeholder information in program structures 32 and/or placeholder information in the project code (e.g., project specific code 40A and/or template code 40B), and create project software program structure 16 that is specific to the client/project and contains information dependent upon parameter inputs 22. Parameter inputs 22 can include various inputs that allow the user/developer to customize project software program structure 16 and any associated components/supporting services.

Parameter inputs 22 can include the following inputs: client name 22A, application/project name 22B, database server name 22C, database name 22D, username 22E, password 22F, custom message 22G, configuration key 22H, and/or cache system key 22I. Parameter inputs 22 can include other inputs not expressly disclosed herein or shown in FIG. 1 and/or FIG. 2B as desired and/or needed by system 10. FIG. 2B shows an example of parameter input dialog box 220 for choosing/inputting parameter inputs 22. Parameter inputs 22A-22I are described below and are shown in the example schematic in FIG. 1 and the example parameter input dialog box 220 in FIG. 2B.

Client name 22A is a parameter input that allows for the user/developer to enter, if applicable, the name of the client (or another designating word and/or phrase) for which project software program structure 16 is being created. Similarly, application/project name 22B allows for the user/developer to enter, if applicable, the name of the project (or another word and/or phrase) for project software program structure 16. The name of the project can be anything determined by the user/developer, the client, or anyone else associated with project software program structure 16. Database server name 22C allows for the user/developer to enter a name of a database to which project software program 16 has access and/or is saved. Additionally, the user/developer can name the database at database name 22D. The user/developer can enter/input username 22E and password 22F that is personal to the user/developer (e.g., allows for later access by the user/developer), that allows access by the client to project software program structure 16 after it is created, is used by system 10 to allow for the creation of project software program structure 16 by the user/developer, and/or for other purposes. The user/developer can also input custom message 22G, which can be displayed anywhere throughout system 10 and/or project software program structure 16 for viewing and/or editing (e.g., custom message can be instructions to users/developers as to the development of additional project code 64 and/or other information). Parameter inputs 22 can include various keys, such as configuration key 22H and cache system key 22I, for security and other purposes. Parameter inputs 22A-22I can have other purposes and/or can be used by system 10 (e.g., by structure creation module 14) for other purposes not disclosed herein.

Selection of the type of project can influence the prompts for parameters inputs. For example, as shown in FIG. 2B, the application/project name and the example solution structure are provided in the parameter input dialog box for an API project, which was selected (by way of example) as the project structure in the new project structure dialog box in FIG. 2A.

As shown in FIG. 2B, parameter input dialog box 220 can allow for entrance, selection, and/or viewing of other information via preview 222. The information shown in preview 222 can dependent upon the information entered/input into/provided by project type selection input 20 and/or parameter inputs 22A-22I. For example, parameter input dialog box 220 can provide preview 222 of classes of the program structure. As shown in FIG. 2B, preview 222 shows classes 36 for selected API structure 32A. In other examples, preview 222 shows the classes and/or layers for web application structure 32B, system software structure 32C, and/or desktop application structure 32D. Parameter input dialog box 220 can be configured to show other information not expressly shown in FIG. 2B.

After input by the user/developer and/or automatic input by system 10 depending upon other factors, project inputs 12 are provided/sent to structure creation module 14. The location/device at which project inputs 12 are entered/selected (e.g., a computer terminal and/or cloud computing and/or storage system) can be in wired and/or wireless communication with structure creation module 14. In another example, the location/device at which project inputs 12 are entered/selected is on/within the same system (e.g., computer terminal and/or cloud computing and/or storage system) as structure creation module 14.

Structure creation module 14 can receive project inputs 12 and use project inputs 12 to: 1) select program structure 32A-32D from program structure database 30, 2) select software code (such as project specific code 40A and/or template code 40B) from software code database 38, 3) substitute/replace placeholders in the program structure 32 and/or the software code (as designated in placeholder database 42 via first token 44A, second token 44B, and third token 44C) with information dependent upon project inputs 12, and 4) create project software program structure 16 having organizational structure 66 as well as project specific runnable software code 60 and/or template code 62.

Structure creation module 14 can include any software and/or hardware for performing any instructions/tasked described herein, and can include other components, capabilities, functionalities, organizations, and/or configurations than those described herein and shown as an example in FIG. 1.

Structure creation module 14 can include program structure database 30 to store and/or allow access to example structures 32A-32D from which structure selection module 50 can select to create project software program structure 16. Program structure database 30 can include storage media within which structures 32A-32D are stored, can use/be in contact with memory 48 of structure creation module 14, and/or can use other electronic/digital/software storage means, such as a cloud storage system. Program structure database 30 can have any organization and/or configuration that allows structure selection module 50 to retrieve the particular structure 32A-32D dependent upon project inputs 12. Program structure database 30 can include any type of program software structure and/or sub-type, and in other examples can include dozens or more program software structures 32 so that structure creation module 14 can create a wide variety of project software program structures 16 depending on the desires/needs of the user/developer and/or the client.

Example system 10 in FIG. 1 shows structure creation module 14 having four example program structures 32: API structure 32A, web application structure 32B, system software structure 32C, and desktop application structure 32D. In the example shown in FIG. 1, API structure 32A is expanded to show example sub-parts/sub-structures, such as layers 34 and/or classes 36. Layers 34 and classes 36 can be used to organize project specific code 40A and/or template code 40B (before placeholders are replaced with information from project inputs 12 by placeholder substitution module 54) as well as runnable software code 60, template code 62, and/or additional project code 64 after the creation of project software program structure 16 by structure creation module 14. Layers 34 can include any number and type of sub-structures, with example layers 34 having business layer 34A, data layer 34B, and user interface layer 34C. Additionally, classes can include any number and type of sub-structures, with example classes 36 having test API class 36A, test business API class 36B, project API class 36C, business class 36D, common class 36E, and data class 36F (as shown in FIG. 2D). Layers 34 and classes 36 can have any organizational relationship, with layers 34 being independent from classes 36, classes 36 being sub-parts/sub-structures of layers 34, and/or another relationship. API structure 32A can have other sub-parts/sub-structures having any organization not expressly shown in example FIG. 1, and the user/developer can add, delete, and/or modify the organization of API structure 32A (and the other structures 32B-32D) as needed.

Web application structure 32B, system software structure 32C, and/or desktop application structure 32D can have a similar structure to one another and to API structure 32A or can have a different structure particularly suitable for the different types of programs to be created. Some or all of these structures/organizations 32 can be known to one of skill in the art as a structure/organization used in that particular type of program, the structures/organizations can be common to the users/developers using system 10 to create project software program structure 16, and/or the structures/organizations can be new such that the particular structures/organizations are not common in the industry.

Structure selection module 50 of structure creation module 14 can include or work in association with processor 46 and/or memory 48 to select one (or multiple) structures 32 from program structure database 30 to form organizational structure 66 for project software program structure 16. The particular structure 32A-32D that structure selection module 50 selects/retrieves is dependent upon project inputs 12 and, more specifically, can be dependent upon project type selection input 20. For example, if API 20A is selected as project type selection input 20, structure selection module 50 can retrieve/select API structure 32A from program structure database 30. The particular structure as selected/retrieved by structure selection module 50 does not need to be selected by the user/developer, but instead system 10 can select/retrieve the particular structure based on inputs 12 and/or 22 without the need for the user/developer to specify the particular structure. Structure selection module 50 can be configured to create a copy of the particular structure 32A-32D to create project software program structure 16 and leave the original structure 32A-32D in program structure database 30 for use in creating another project software program structure 16 for another project. Structure selection module 50 can automatically perform the selection/retrieval of the particular structure 32A-32D depending on project inputs 12, or structure selection module 50 can be used by the user/developer to select structure 32A-32D. Structure selection module 50 can include other components, capabilities, functions, and configurations not expressly disclosed herein for use in creating project software program structure 16 depending on project inputs 12.

Structure creation module 14 can include software code database 38 to store and/or allow access to project specific code 40A and/or template code 40B from which code selection module 52 can select to add software code to one of program structures 32A-32D to create project software program structure 16. Software code database 38 can include storage media within which project specific code 38 and/or template code 40B are stored, can use/be in contact with memory 48 of structure creation module 14, and/or can use other electronic/digital/software storage means, such as a cloud storage system. Software code database 38 can have any organization and/or configuration that allows code selection module 52 to select and retrieve all or some portions of project specific code 40A and/or template code 40B.

Project specific code 40A can include a wide variety of portions/blocks of code that are specific to one or multiple structures 32A-32D. Project specific code 40A can include placeholders that, when substituted by placeholder substitution module 54 with information depending on project inputs 12, result in runnable software code 60 in project software program structure 16. Some or all of project specific code 40A can be selected for project software program structure 16. Template code 40B can include a wide variety of portions/blocks of code and/or other information that can serve as a roadmap/instructions for users/developers to create/write additional project code 64 after project software program structure 16 has been created by structure creation module 14. Template code 40B can include anything useful to the users/developers in creating/writing additional project code 64, and can additionally include placeholders that are substituted with information from project inputs 12. Once selected and added to structure 32A-32D to create project software program structure 16, template code 40B becomes template code 62. Template code 62 differs from runnable software code 60 in project software program structure 16 in that template code 62 is not runnable without further modification, addition, and/or deletion of some or all of template code 62 by a user/developer. Once some or all of template code 62 is modified, template code 62 can become additional project code 64 that is runnable.

Code selection module 52 of structure creation module 14 can include or work in association with processor 46, memory 48, structure selection module 50, and/or other components of system 10 to select all or a portion of project specific code 40A and/or template code 40B. Code selection module 52 can select the portions of project specific code 40A and/or template code 40B depending on project inputs 12, or code selection module 52 can select all of project specific 40A and template code 40B to include in the created project software program structure 16 for the user/developer to add to, delete, and/or modify depending on client needs and project functionality. Code selection module 52 can be configured to insert the selected project specific code 40A and/or template code 40B into the proper location within structure 32 (i.e., the particular structure 32A-32D that is selected by structure selection module 50 to create project software program structure 16), or the insertion of the selected project specific code 40A and/or template code 40B can be performed by structure creation module 14 and/or another component of structure creation module 14. The location at which the selected project specific code 40A and/or template code 40B is inserted into the selected structure 32A-32D can be dependent upon project inputs 12 (e.g., dependent upon project type selection input 20 and/or parameter inputs 22). Code selection module 52 can be configured to create a copy of the selected project specific code 40A and template code 40B to add to/insert into the selected structure 32 to create project software program structure 16 and leave the original project specific code 40A and template code 40B in software code database 30 for use in creating another project software program structure 16 for another project. Code selection module 52 can automatically perform the code selection/retrieval depending on project inputs 12, or code selection module 52 can be used by the user/developer to select all or some portions/blocks of project specific code 40A and/or template code 40B to include/insert into the selected structure 32. Code selection module 52 can include other components, capabilities, functions, and configurations not expressly disclosed herein for use in creating project software program structure 16 depending on project inputs 12.

Structure creation module 14 can also include placeholder database 42 to store and/or allow access to information regarding the location of placeholders as well as information regarding to which project inputs 12 the placeholders correspond. This information can be used by placeholder substitution module 54 to perform replacement/substitution of the placeholders with information from the corresponding project inputs 12. Placeholder database 42 can include storage media within which the location information of the placeholders (and/or other information) is stored, can use/be in contact with memory 48 of structure creation module 14, and/or can use other electronic/digital/software storage means, such as a cloud storage system. Placeholder database 42 can have any organization and/or configuration that allows placeholder substitution module 54 to locate and replace/substitute the placeholders in structures 32A-32D, project specific codes 40A, and/or template code 40B.

Placeholder database 42 can include a list of placeholders, which can include structure placeholders (i.e., placeholders present in structures 32) and code placeholders (i.e., placeholders present in project specific code 40A and/or template code 40B). Placeholder substituted module 54 can be in communication with placeholder database 42 to access the list of placeholders. Placeholder database 42 can include one or multiple tokens, such as examples first token 44A, second token 44B, and third token 44C. Tokens 44A-44C associate/link placeholders in structure 32, project specific code 40A, and/or template code 40B with information from project inputs 12 so that placeholder substitution module 54 can perform the substitution/replacement. Each of tokens 44A-44C can be linked to one or multiple placeholders, and then the relevant project inputs 12 can be associated with that token 44A-44C so that placeholder substitution module 54 can replace the placeholders with information from the corresponding project inputs 12.

In the disclosed example, first token 44A can correspond to a placeholder in API structure 32A regarding a placeholder for a client name, so first token 44A can link and/or associate the placeholder with client name 22A of parameter inputs 22. Then, placeholder substitution module 54 can replace/substitute the placeholder in API structure 32A with information dependent upon client name 22A (which can be the actual client name or other information dependent upon the entry in client name 22A). Second token 44B can correspond to a placeholder in project specific code 40A regarding a placeholder for a configuration key, so second token 44B can link and/or associate the placeholder with configuration key 22H, and placeholder substitution module 54 can replace/substitute this placeholder with information dependent upon configuration key 22H. Similarly, third token 44C can correspond to a placeholder in template code 40B regarding a placeholder for a username, so third token 44C can link and/or associate the placeholder with username 22E, and placeholder substitution module 54 can replace/substitute this placeholder with information dependent upon username 22E.

Placeholder database 42 having a list of placeholders and/or tokens 44A-44C for storing the location of placeholders, linking the tokens to those placeholders, and associating the tokens with the corresponding information from project inputs 12 allows placeholder substitution module 54 to perform the replacement/substitution of the placeholders. Placeholder database 42 can include placeholders for all structures 32A-32D such that some placeholders will not be replaced/substituted depending on whether that particular project type is selected in project inputs 12 and/or whether that particular code is included in the selected structure 32.

Placeholder substitution module 54 of structure creation module 14 can include or work in association with processor 46, memory 48, and/or any other components of structure creation module 14 to replace/substitute the placeholders in structure 32A-32D, project specific code 40A, and/or template code 40B with information from/dependent upon project inputs 12. Placeholder substitution module 54 can be in communication with project inputs 12 (e.g., receive project inputs 12) and placeholder database 42. Placeholder substitution module 54 can automatically perform the substitution depending on project inputs 12, or placeholder substitution module 54 can be used by user/developer to select and replace all or some of the placeholders.

The replacement/substitution of the placeholder can include both the replacement/substitution of that placeholder in placeholder database 42 and/or the replacement/substitution of that placeholder in structure 32A-32D, project specific code 40A, and/or template code 40B with information from/dependent upon project inputs 12. All of the placeholders in every portion of project specific code 40A can be substituted by placeholder substitution module 54, or only the portions of project specific code 40A particular to the selected structure 32 (in this example, API structure 32A) can be substituted to create runnable software code 60.

Structure creation module 14 (and/or other components of system 10) can include one or multiple computer/data processors 46 (also referred to as “processor 46”). In general, processor 46 can include any or more than one of a processor, a microprocessor, a controller, a digital signal processor (DSP), an application specific integrated circuit (ASIC), a field-programmable gate array (FPGA), or other equivalent discrete or integrated logic circuitry. Processor 46 can perform instructions stored within storage media, such as memory 48 (or located elsewhere), and/or processor 46 can include storage media such that processor 46 is able to store instructions and perform the functions described herein. Additionally, processor 46 can perform other computing processes described herein, such as the functions performed by structure creation module 14, structure selection module 50, code selection module 52, placeholder substitution module 54, and/or other components of system 10.

Structure creation module 14 (and/or other components of system 10) can also include memory 48. Memory 48 is configured to store information and, in some examples, can be described as a computer-readable storage medium. Memory 48, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 64 is a temporary memory. As used herein, a temporary memory refers to a memory having a primary purpose that is not long-term storage. Memory 48, in some examples, is described as volatile memory. As used herein, a volatile memory refers to a memory that that the memory does not maintain stored contents when power to memory 48 is turned off. Examples of volatile memories can include random access memories (RAM), dynamic random access memories (DRAM), static random access memories (SRAM), and other forms of volatile memories. In some examples, the memory is used to store program instructions for execution by the processor. The memory, in one example, is used by software or applications running on structure creation module 14 to temporarily store information during program execution.

Memory 48, in some examples, also includes one or more computer-readable storage media. Memory 48 can be configured to store larger amounts of information than volatile memory. Memory 48 can further be configured for long-term storage of information. In some examples, memory 48 includes non-volatile storage elements. Examples of such non-volatile storage elements can include, for example, magnetic hard discs, optical discs, floppy discs, flash memories, or forms of electrically programmable memories (EPROM) or electrically erasable and programmable (EEPROM) memories. As shown in the example of structure creation module 14, memory 48 can store project inputs 12, program structure database 30, software code database 38, and/or placeholder database 42.

After selection of structure 32, selection of project specific code 40A and/or template code 40B, and substitution of the placeholders, structure creation module 14 can create project software program structure 16, with an example shown in FIGS. 2C and 2D as interface 320. As described above, project software program structure 16 can be configured particularly for a client to include client specific information. Project software program structure 16 can include organizational structure 66, shown to the right in FIG. 2C and enlarged in FIG. 2D. Within organizational structure 66 can be runnable software code 60, template code 62, and/or additional project code 64, which is organized for easy access, viewing, and modification by a user/developer/client, and for easy access for performance of instructions detailed in the code by various software and/or hardware.

Project software program structure 16 can include runnable software code 60, template code 62, and/or additional project code 64, which is shown to the left in FIG. 2C. Project software program structure 16 can include runnable software code 60 such that, upon creation, project software program structure 16 is ready for use and can be checked into client repository 18 so that project software program structure 16 (e.g., the program/project) can be stored and/or used by the client.

Template code 62 within project software program structure 16 can be configured such that it does not interfere with the performance of runnable software code 60 and, if desired, project software program structure 16 can be fully runnable even if it contains template code 62. Template code 62 (similar to template code 40B in software code database 38), can be included in project software program structure 16 to provide a roadmap/instructions to users/developers in creating/writing additional project code 64 by listing any code that still needs to be written/developed, by providing location details for linking the yet-to-be-written code to other code/data, and/or by containing other information. Template code 62 differs from template code 40B in that template code 62 has been copied to/inserted into organizational structure 66 of project software program structure 16 while template code 40B remains within software code database 38 for use by structure creation module 14.

Project software program structure 16 can also include additional project code 64, which can be written/created using template code 62 or can be written/created from scratch without the use of previous templates and/or code. Additional project code 64 can be specific to the project (for which project software program structure 16 is created) and can be created/written by a user/developer before, during, or after project software program structure 16 is created. Additional project code 64 can be inserted into project software program structure 16 after the creation of project software program structure 16. Additional project code 64 can contain any code, information, data, etc. for use in the operation of project/program (or for other uses, such as the storage of the program/project, the granting and/or limiting of access to the program/project, etc.). In one example, project software program structure 16 does not need to include additional project code 64, and project/program can function/operate without the need for additional project code 64.

Once created, edited, and/or added to, the project/program having project software program structure 16 can be checked into and/or stored in client repository 18. Client repository 18 can be located at a location specified by the client and/or can be controlled by the client such that the project/program can be accessed, viewed, and/or manipulated by the client or another user/developer. Client repository 18 can have any components, capabilities, functions, configurations, and/or organizations as necessary for the performance/operation of the project/program having project software program structure 16.

As described herein, system 10 can create project software program structure 16 for a project/program dependent upon project inputs 12, which can be selected by a user/developer. Project software program structure 16, which can have a consistent, replicable organization, can be created by structure creation module 14. Structure creation module 14 can receive project inputs 12 and use project inputs 12 to: 1) select program structure 32 from program structure database 30, 2) select software code (such as project specific code 40A and/or template code 40B) from software code database 38, 3) substitute/replace placeholders in the program structure and/or the software code (as designated in placeholder database 42 via examples first token 44A, second token 44B, and third token 44C) with information dependent upon project inputs 12, and 4) create project software program structure 16 having the project specific program structure (i.e., organizational structure 66) as well as project specific runnable software code 60, template code 64, and/or additional project code 66. A project/program with a consistent, replicable structure allows for the users/developers to more easily add to and/or manipulate the structure and/or code. Project software program structure 16 can have a structure familiar to the client, making review and operation of the project/program easier. Additionally, this consistency makes writing and inserting new code into the known structure/organization of project software program structure 16 quicker and easier. Further, project specific code 40A and/or template code 40B can be “best practices” code that has been developed and refined to be code that is the most efficient, easily editable, simplest, shortest, transferrable, etc. System 10 can create a variety of different types of software program structures (e.g., projects/programs) having different organizations/structures suitable for the project/program, making system 10 highly variable and useful in developing/creating numerous different programs.

### Discussion of Possible Embodiments

The following are nonlimiting examples of the systems and related processes for automated program structure creation having runnable software code:

A method of creating a software program structure for a project, the method comprising: collecting a plurality of project inputs that includes a type of software program that is to be created and at least one of the following: client name, application/project name, database server name, database name, username, password, custom message, configuration key, and cache system key; replacing at least one structure placeholder in the software program structure with first project information dependent upon the plurality of project inputs and at least one code placeholder in software code of the software program structure with second project information dependent upon the plurality of project inputs; and providing the software program structure for the project that includes first project information and software code that include second project information, wherein the software code is fully runnable software code that does not require further editing.

The method of the preceding paragraph can optionally include, additionally and/or alternatively, any one or more of the following features, configurations and/or additional components:

A further embodiment of the foregoing method, wherein the step of replacing at least one structure placeholder in the software program structure and at least one code placeholder in software code of the software program structure further comprises: accessing a placeholder database that contains a list of the at least one structure placeholder and the at least one code placeholder in the software code of the software program structure.

A further embodiment of the foregoing method, further comprising: selecting the software program structure from a software program structure database.

A further embodiment of the foregoing method, further comprising: retrieving the software code from a software code database.

A further embodiment of the foregoing method, further comprising: checking in the project that includes the software program structure and the software code into a client repository.

A further embodiment of the foregoing method, wherein the software program structure is one of the following: an application programming interface, a web application, a system software structure, and a desktop application.

A further embodiment of the foregoing method, further comprising: accessing a placeholder database that contains a list of the at least one structure placeholder and the at least one code placeholder.

A further embodiment of the foregoing method, further comprising: linking a first placeholder of the at least one structure placeholder to a first token in the placeholder database; associating a first project input of the plurality of project inputs with the first token; and replacing the first placeholder with the first project information dependent upon the first project input via the first token.

A further embodiment of the foregoing method, further comprising: selecting the software program structure dependent upon the type of software program that is to be created as collected in the plurality of project inputs.

A further embodiment of the foregoing method, further comprising: selecting the software code within the software program structure dependent upon the type of software program that is to be created as collected in the plurality of project inputs.

A further embodiment of the foregoing method, further comprising: adding additional software code specific to the project having the software program structure.

A further embodiment of the foregoing method, wherein the software code within the software program structure includes template code configured to be used in writing additional software code specific to the project.

A system for creating a software program structure for a project, the system being located on computer hardware and comprising: a project input file having a plurality of project inputs that includes a type of software program that is to be created and at least one of the following parameter inputs: client name, application/project name, database server name, database name, username, password, custom message, configuration key, and cache system key; a placeholder database that contains a list of at least one structure placeholder in the software program structure and the at least one code placeholder in software code of the software program structure; a structure creation module in communication with the project input file and the placeholder database, structure creation module having a computer processor and configured to replace the at least one structure placeholder in the software program structure with first project information dependent upon the plurality of project inputs and replace the at least one code placeholder in software code of the software program structure with second project information dependent upon the plurality of project inputs; and the software program structure that includes the software code having the second project information with the software code being fully runnable software cod that does not require further editing.

The system of the preceding paragraph can optionally include, additionally and/or alternatively, any one or more of the following features, configurations and/or additional components:

A further embodiment of the foregoing system, wherein the structure creation module further comprises: a program structure database that includes at least one software program structure for the type of software program that is to be created.

A further embodiment of the foregoing system, wherein the structure creation module further comprises: a software code database from which a type of software program structure is retrieved dependent upon the plurality of project inputs.

A further embodiment of the foregoing system, further comprising: a client repository to which the project having the software program structure including software code is checked in and stored.

A further embodiment of the foregoing system, wherein the placeholder database includes at least one token that associates the plurality of project inputs with the at least one structure placeholder and the at least one code placeholder.

A further embodiment of the foregoing system, wherein the structure creation module further comprising: memory for storing a program structure database, a software code database, and the placeholder database.

A further embodiment of the foregoing system, wherein the structure creation module further comprises: a structure selection module configured to select the software program structure from a program structure database dependent upon the plurality of project inputs; a code selection module configured to select the software code from a software code database dependent upon the plurality of project inputs; and a placeholder substitution module configured to replace the at least on structure placeholder with first project information dependent upon the plurality of project inputs and replace the at least on code placeholder with second project information dependent upon the plurality of project inputs.

A further embodiment of the foregoing system, further comprising: template code configured to be used in writing additional software code specific to the project having the software program structure.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of creating a software program structure for a project, the method comprising:
collecting a plurality of project inputs that includes a type of software program that is to be created and at least one of the following: client name, application/project name, database server name, database name, username, password, custom message, configuration key, and cache system key;
replacing at least one structure placeholder in the software program structure with first project information dependent upon the plurality of project inputs and at least one code placeholder in software code of the software program structure with second project information dependent upon the plurality of project inputs; and
providing the software program structure for the project that includes first project information and software code that include second project information, wherein the software code is fully runnable software code that does not require further editing.

2. The method of claim 1, wherein the step of replacing at least one structure placeholder in the software program structure and at least one code placeholder in software code of the software program structure further comprises:
accessing a placeholder database that contains a list of the at least one structure placeholder and the at least one code placeholder in the software code of the software program structure.

3. The method of claim 1, further comprising:
selecting the software program structure from a software program structure database.

4. The method of claim 1, further comprising:
retrieving the software code from a software code database.

5. The method of claim 1, further comprising:
checking in the project that includes the software program structure and the software code into a client repository.

6. The method of claim 1, wherein the software program structure is one of the following: an application programming interface, a web application, a system software structure, and a desktop application.

7. The method of claim 1, further comprising:
accessing a placeholder database that contains a list of the at least one structure placeholder and the at least one code placeholder.

8. The method of claim 7, further comprising:
linking a first placeholder of the at least one structure placeholder to a first token in the placeholder database;
associating a first project input of the plurality of project inputs with the first token; and
replacing the first placeholder with the first project information dependent upon the first project input via the first token.

9. The method of claim 1, further comprising:
selecting the software program structure dependent upon the type of software program that is to be created as collected in the plurality of project inputs.

10. The method of claim 1, further comprising:
selecting the software code within the software program structure dependent upon the type of software program that is to be created as collected in the plurality of project inputs.

11. The method of claim 1, further comprising:
adding additional software code specific to the project having the software program structure.

12. The method of claim 11, wherein the software code within the software program structure includes template code configured to be used in writing additional software code specific to the project.

13. A system for creating a software program structure for a project, the system being located on computer hardware and comprising:
a project input file having a plurality of project inputs that includes a type of software program that is to be created and at least one of the following parameter inputs:
client name, application/project name, database server name, database name, username, password, custom message, configuration key, and cache system key;
a placeholder database that contains a list of at least one structure placeholder in the software program structure and the at least one code placeholder in software code of the software program structure;
a structure creation module in communication with the project input file and the placeholder database, structure creation module having a computer processor and configured to replace the at least one structure placeholder in the software program structure with first project information dependent upon the plurality of project inputs and replace the at least one code placeholder in software code of the software program structure with second project information dependent upon the plurality of project inputs; and
the software program structure that includes the software code having the second project information with the software code being fully runnable software cod that does not require further editing.

14. The system of claim 13, wherein the structure creation module further comprises:
a program structure database that includes at least one software program structure for the type of software program that is to be created.

15. The system of claim 13, wherein the structure creation module further comprises:
a software code database from which a type of software program structure is retrieved dependent upon the plurality of project inputs.

16. The system of claim 13, further comprising:
a client repository to which the project having the software program structure including software code is checked in and stored.

17. The system of claim 13, wherein the placeholder database includes at least one token that associates the plurality of project inputs with the at least one structure placeholder and the at least one code placeholder.

18. The system of claim 13, wherein the structure creation module further comprising:
memory for storing a program structure database, a software code database, and the placeholder database.

19. The system of claim 13, wherein the structure creation module further comprises:
a structure selection module configured to select the software program structure from a program structure database dependent upon the plurality of project inputs;
a code selection module configured to select the software code from a software code database dependent upon the plurality of project inputs; and
a placeholder substitution module configured to replace the at least on structure placeholder with first project information dependent upon the plurality of project inputs and replace the at least on code placeholder with second project information dependent upon the plurality of project inputs.

20. The system of claim 19, further comprising:
template code configured to be used in writing additional software code specific to the project having the software program structure.
